(19) United States
(12) Patent Application Publication
(10) Pub. No.: US 2013/0210565 A1
(43) Pub. Date: Aug. 15, 2013

(54) BASEBALL OR SOFTBALL AND COVER FORMING METHOD THEREOF

(71) Applicant: SHYI-MING CHEN, Kaohsiung City (TW)

(72) Inventor: SHYI-MING CHEN, Kaohsiung City (TW)

(21) Appl. No.: 13/453,315

(22) Filed: Apr. 23, 2012

(30) Foreign Application Priority Data
Feb. 13, 2012 (CN) 201210031266.3

(51) Int. Cl. A63B 37/12; B29C 70/68

(52) U.S. Cl. 473/598; 156/245

(57) ABSTRACT

A cover method for baseballs or softballs, whereby a spherical core is independently formed and a fiber material layer is attached, this fiber material layer is evenly brushed with a thin layer of PU, and this spherical core is then placed in a mold, and PU is injected into the mold to cover the spherical core and heated, finally the mold is removed to reveal the complete ball. Utilizing this method and mold to produce the ball covers for baseballs and softballs, whereby PU is brushed onto, and penetrates into, the fiber material layer on the independently formed spherical core, so that when the ball cover forms, the ball cover and spherical core attaches and fits firmly, and the porous construction of this fiber material cover attracts air, and therefore greatly avoids bubbles forming when the ball cover is formed which affects the quality and lifespan of the balls.

### BACKGROUND OF THE INVENTION

1. Field of the Invention

This invention is a cover forming method for a baseball or softball, especially the production process for the cover forming method.

2. Description of Related Art

Presently, the structure of baseballs and softballs for competition is constructed mainly of an elastic spherical core covered in a leather cover. Because of the quality of the leather cover and high labor costs, production rates are low and there are flaws in the uniformity of each ball, and therefore PU material has been used for the ball covers. As for this PU material and the current production method of the ball and the ball layer, it generally involves an independently manufactured spherical core being placed in the center of two semicircular molds, or this spherical core being placed into two corresponding figure of 8 shaped molds, and then PU material being injected into the molds to cover the spherical core, and then the molds being removed to reveal the complete ball.

This production method still has several flaws. After PU material is injected through the inlet grooves on the body of the ball cover mold to the cavity of the ball cover mold which has the spherical core inside, the PU material covers the spherical core. Air outlets are set on both sides of the inlet grooves which connect to the inside of the mold, but as these outlets are only situated at the top when the mold is heated and foam is produced, the gas possibly can't all be released out the air outlets, and this small amount of gas which can't be expelled forms air bubbles in the PU in the mold, and these bubbles left in the outside cover result in uneven integrity and thickness of the outside covers, and thus result in flaws in the outside covers. The outside cover is formed by injecting liquid PU material onto the spherical core, and because this spherical core is made from either PU, rubber or cork, the surface of this spherical core doesn't have a strong bond, and doesn't attach strongly to the foam formed in the PU, resulting in a loose attachment between the spherical core and ball cover, which results in a shortened lifespan and the ball easily changing shape.

Therefore, how to solve the above problems is an issue demanding a prompt solution by industry.

### SUMMARY OF THE INVENTION

This purpose of this invention is to provide a baseball or softball and a cover forming method thereof to solve the problem of bubbles being produced in the ball cover and the loose attachment between the spherical core and ball cover in the conventional technique.

To achieve the above mentioned goals, this invention solves the problems by utilizing the following methods:

A baseball or softball includes an independently formed spherical core and a ball cover covering the spherical core, and wherein a fiber material layer is set between the spherical core and the ball cover.

The fiber material layer covers the spherical core, then the fiber material layer is coated with a layer of PU, so that during the second forming phase of the ball cover, the PU layer coats the outer fiber material layer.

A method for forming a ball cover of a baseball or softball, includes the following steps:
(a) firstly forming of an independent spherical core;
(b) attaching a fiber material layer on the outer surface of the spherical core, and the fiber material layer is then evenly brushed with a thin layer of PU;
(c) placing the spherical core in a mold of the ball cover;
(d) injecting a PU material into a cavity of the mold of the ball cover to cover the spherical core and to be heated; and
(e) finally removing the mold to reveal a complete shaped ball.

In step (a), the spherical core is one selected from the following: a PU, a rubber, a cork and multi-layer winding yarn.

In step (b), the fiber material layer is a non-woven fabric.

In step (b), the fiber material layer is a woven cloth.

In step (b), the fiber material layer is one selected from the following: a cotton yarn and a woolen yarn.

In step (c), the mold of the ball cover is constructed from two corresponding figure of 8 shaped mold pieces, the two mold pieces fitting together to form the ball cover, the two mold pieces made from a soft material, a joining edge formed where the two mold pieces meet, and grooves set on an inside side of the joining edge to form a raised sewn section on the ball cover and protrusions extending towards an inside of the mold cavity, these protrusions being protruding supports to support the ball core, and a material inlet and an air outlet set where the two mold pieces join.

Utilizing this invention method and mold to produce the outer covers for baseballs and softballs, whereby PU is brushed onto, and penetrates into, the fiber material layer on the independently formed spherical core to form a composite layer attaching to the spherical core, so that when the ball cover forms, the ball cover material and the composite layer become one unit, which allows for an enhanced adhesion between the surface of the ball cover and the spherical core, and the ball cover and spherical core attaches and fits firmly, and the porous construction of this fiber material cover attracts air, and therefore greatly avoids bubbles forming when the outer cover is formed, which affects the quality and lifespan of the balls.

### BRIEF DESCRIPTION OF THE DRAWINGS

FIG. 1 is a structural schematic diagram showing the spherical core covered by the fiber material layer of the present invention.

FIG. 2 is a cross sectional diagram showing the formed sphere of the present invention.

FIG. 3 is a schematic diagram showing the embodiment of a ball cover mold of the present invention; and

FIG. 4 is a schematic diagram showing the production process of the present invention.

### DETAILED DESCRIPTION OF THE INVENTION

The invention, as well as its many advantages, may be further understood by the following detailed description and drawings:

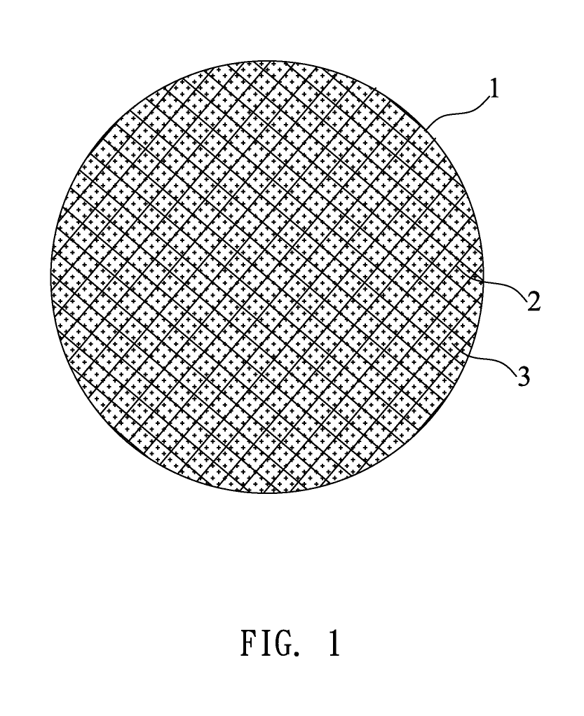

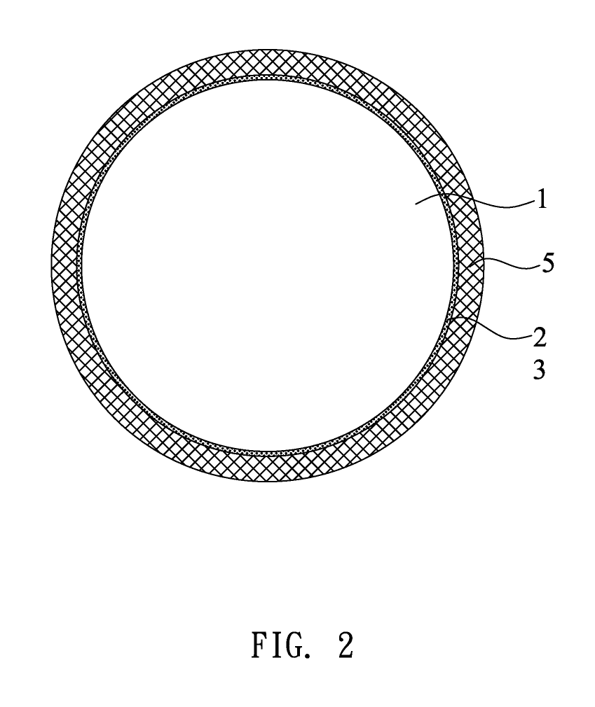

Please refer to both FIG. 1 and FIG. 2, the present invention discloses a baseball or softball including an independent spherical core 1 and a ball cover 5 covering the spherical core 1, and wherein a fiber material layer 2 is set between the spherical core 1 and the ball cover 5, the fiber material layer 2 covers the spherical core 1, then the fiber material layer is coated with a layer of PU 3, so that when the ball cover 5 is formed in the second forming phase, the layer of PU 3 is coated on the fiber material layer 2.

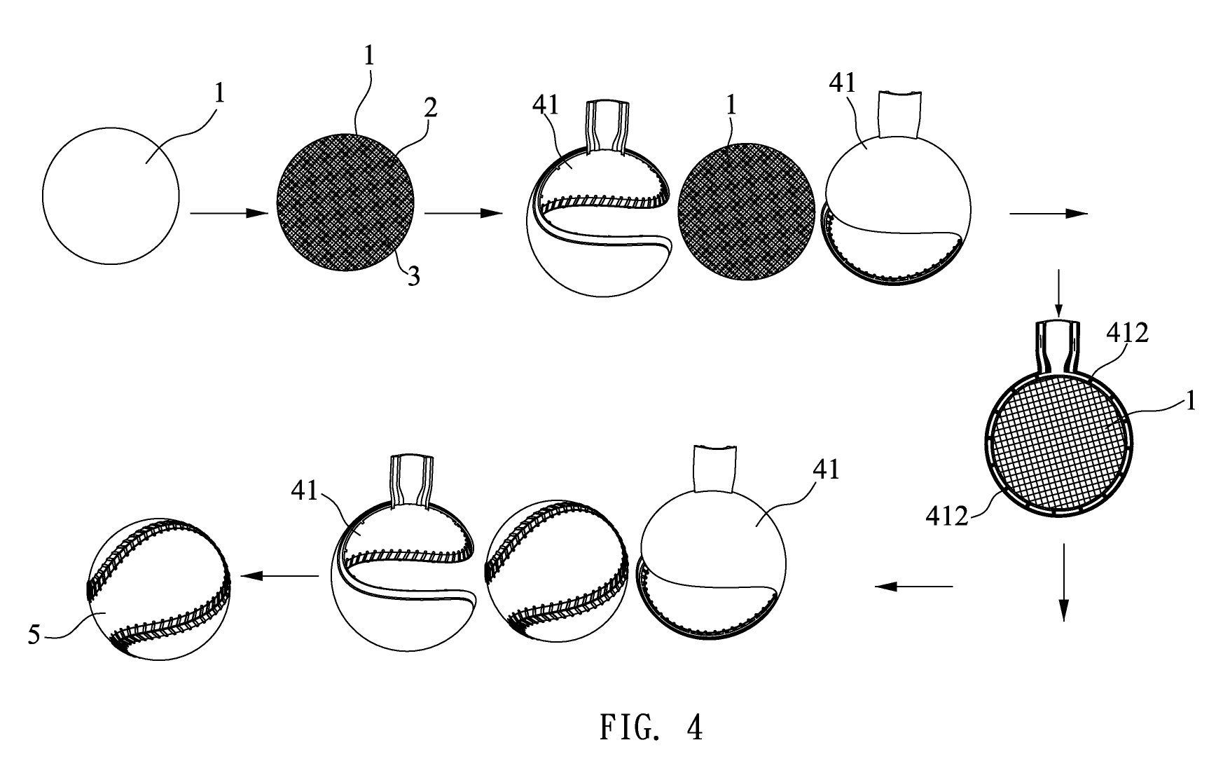

Please refer to both FIG. 1 and FIG. 4, the method for forming a baseball or softball includes the following steps:
(a) firstly forming an independent spherical core;
(b) attaching a fiber material layer on the outer surface of the spherical core, and the fiber material layer is then evenly brushed with a thin layer of PU;
(c) placing the spherical core in a mold of the ball cover;
(d) injecting a PU material into a cavity of the mold of the ball cover to cover the spherical core and to be heated; and
(e) finally removing the mold to reveal a complete shaped ball.

Please again refer to both FIG. 1 and FIG. 2, which show the independently formed spherical core 1 used in the present invention, whereby the spherical core is selected from one of the following: a PU, a rubber, a cork and multi-layer winding yarn.

In this invention, before the spherical core 1 is put into the mold of the ball cover, the fiber material layer 2 is first attached, wound and wrapped onto the outer surface of the spherical core 1. The fiber material is a porous structure when distributed, and is one selected from the following: a fiber cotton yarn, a woolen yarn, a fiber winding layer and a woven cloth. In this embodiment, the fiber material layer 2 utilizes a non-woven fabric to be coated on the surface of the spherical core 1, the non-woven fabric is evenly brushed with a thin layer of PU to form the PU layer 3, and which allows the PU to penetrate into the non-woven fabric to form a composite layer, therefore the PU fiber layer attaches and fits onto the outer surface of the spherical core 1.

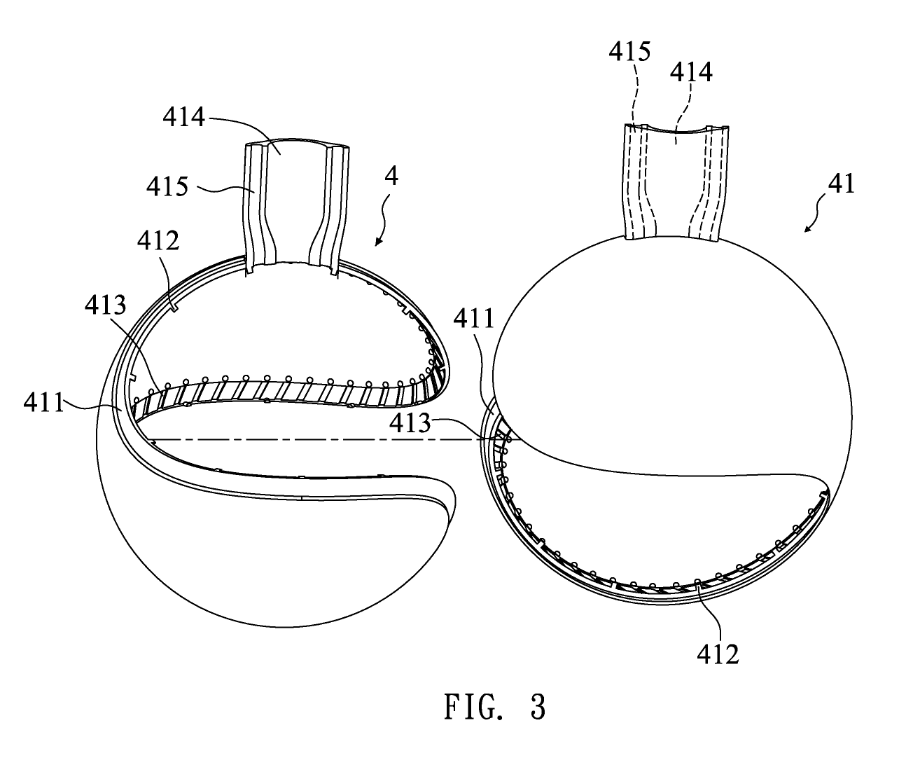

Please refer to both FIG. 3 and FIG. 4, and then the spherical core 1, coated with the non-woven fabric, is placed in the mold 4 of the ball cover to form a ball cover. In this embodiment, the mold 4 of the ball cover is constructed from two corresponding figure of 8 shaped mold pieces 41, the two mold pieces 41 fitting together to form the ball cover, the two mold pieces 41 made from a soft material, a joining edge 411 formed where the two mold pieces 41 meet, and grooves 413 set on an inside side of the joining edge 411 to form a raised sewn section on the ball cover 5 and protrusions 412 extending towards an inside of a mold cavity, these protrusions 412 being protruding supports to support the ball core 1 and to control the thickness of the ball cover 5, and a material inlet 414 and an air outlet 415 are set at the joining edge 411 of the two mold pieces 41. On joining edge 411 of the mold piece 41, a protrusion is set having material inlet groove 414 which connects to the inside side of mold piece 41; air outlet grooves 415 are set on two sides of material inlet groove 414 which connect to the inside side of mold piece 41 to balance the pressure inside the mold 4 of the ball cover.

The two mold pieces 41 fit together to form the complete ball cavity, at the same time material inlet grooves 414 dock together to form a material inlet, and the two sets of air outlet grooves 415 dock together to form air outlet situated on two sides of material inlet. The ball cover used in the invention can certainly also be constructed from two hemispherical molds which fit together.

After the spherical core 1 is placed into the mold 4 of the ball cover, the PU material is injected into the mold cavity, to cover the spherical core 1 and form the ball cover 5.

Using the PU material can effectively reduce the cost of materials; moreover using the mold 4 of the ball cover to directly form a ball cover in one step and produced by mechanization can effectively improve productivity and ensure a unified performance of the products.

The ball cover 5 formed as one body, having a good outside integrated appearance, can effectively improve the lifespan of the balls.

When the ball cover 5 is formed in the mold 4 of the ball cover at high temperature, the non-woven cloth on the surface of the spherical core 1 has the properties of high temperature resistance, porosity, moisture permeability and ventilation.

The PU is smeared onto, and finally penetrates into the non-woven cloth, so that the non-woven cloth is further cured, then attaches and fits onto the surface of the spherical core 1. In the process whereby high temperature injection molding forms the ball cover 5, and the PU material is coated on the spherical core 1, the PU material can be fused with the PU in the non-woven cloth. When the PU is at the high-temperature and foam forms, a part of the gas is unable to be timely and completely expelled from the air outlet, and some small bubbles can be absorbed by the non-woven cloth with the porous structure which has air absorbing properties, and therefore greatly avoids the issue of generating bubbles unevenly and untimely during the foam molding process.

Finally the mold is removed to reveal a complete shaped ball.

Utilizing this invention method and mold to produce the ball cover 5 for baseballs and softballs, whereby PU is brushed onto, and penetrates into the fiber material layer 2, which is a non-woven fabric in this embodiment, and forms a composite layer attached on the independently formed spherical core 1, so that when the ball cover 5 forms, the ball cover 5 material and the composite layer become one unit, which allows for enhanced adhesion between the surface of the ball cover 5 and the spherical core 1 , and the ball cover 5 and spherical core 1 attach and fit firmly together, and the porous construction of this fiber material cover attracts air, and therefore greatly avoids bubbles forming when the ball cover 5 is formed, affecting the quality and lifespan of the balls.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A baseball or softball, comprising a spherical core formed independently and a ball cover covering the spherical core, characterized in that: a fiber material layer is set between the spherical core and the ball cover.

2. The baseball or softball of claim 1, wherein the fiber material layer covers the spherical core, then the fiber material layer is coated with a layer of PU, so that when the ball cover is in the second forming phase, the layer of PU is coated on the fiber material layer.

3. A method for forming a ball cover of a baseball or softball, comprising the following steps:
(a) firstly forming an independent spherical core;
(b) attaching a fiber material layer on the outer surface of the spherical core, and the fiber material layer is then evenly brushed with a thin layer of PU;
(c) placing the spherical core in a mold of the ball cover;
(d) injecting a PU material into a cavity of the mold of the ball cover to cover the spherical core and to be heated; and
(e) finally removing the mold to reveal a complete shaped ball.

4. The method for forming a ball cover of a baseball or softball of claim 3, wherein the spherical core is one selected from the group consisting of: a PU, a rubber, a cork and multi-layer winding yarn.

5. The method for forming a ball cover of a baseball or softball of claim 3, wherein the fiber material layer is a non-woven fabric.

6. The method for forming a ball cover of a baseball or softball of claim 3, wherein the fiber material layer is a woven cloth.

7. The method for forming a ball cover of a baseball or softball of claim 3, wherein the fiber material layer is one selected from the group consisting of: a cotton yarn and a woolen yarn.

8. The method for forming a ball cover of a baseball or softball of claim 3, wherein the mold of the ball cover is constructed from two corresponding figure of 8 shaped mold pieces, the two mold pieces fitting together to form the ball cover, the two mold pieces made from a soft material, and a joining edge formed where the two mold pieces meet, and grooves set on an inside side of the joining edge to form a raised sewn section on the ball cover and protrusions extending towards an inside of a mold cavity, these protrusions being protruding supports to support the ball core, and a material inlet and an air outlet set where the two mold pieces join.
